(19) United States
(12) Patent Application Publication
(10) Pub. No.: US 2025/0042462 A1
(43) Pub. Date: Feb. 6, 2025

(54) STROLLER ASSEMBLY

(71) Applicants: Steven G. GERHART, Reinholds, PA (US); Bruce L. WILLIAMS, Narvon, PA (US); Wonderland Switzerland AG, Steinhausen (CH)

(72) Inventors: Steven G. GERHART, Reinholds, PA (US); Bruce L. WILLIAMS, Narvon, PA (US)

(21) Appl. No.: 18/718,662

(22) PCT Filed: Dec. 8, 2022
(86) PCT No.: PCT/US2022/052290

§ 371 Date: Jun. 11, 2024

Related U.S. Application Data
(60) Provisional application No. 63/265,328, filed on Dec. 13, 2021.

(51) Int. Cl. B62B 9/28; B62B 5/08

(52) U.S. Cl. CPC B62B 9/28; B62B 5/087

(57) ABSTRACT

A stroller board removably mountable to a stroller. The stroller board includes a child support platform including at least one wheel which, when the stroller board is in a use position, rests on the ground; a first arm extending between a first end coupled to the child support platform and a second end; and a first stroller board mount coupled to the second end of the first arm. The first stroller board mount has a structure that defines 1) an interior that is configured to slidably receive a terminal end of a first stroller mount of the stroller to couple the first stroller board mount to the first stroller mount or 2) a protrusion having a terminal end that is configured to be slidably received in an interior of the first stroller mount of the stroller to couple the first stroller board mount to the first stroller mount.

### PRIORITY CLAIM

The present application claims priority to U.S. Provisional Patent Application Ser. No. 63/265,328 filed Dec. 13, 2021; the disclosure of which is incorporated herewith by reference.

### BACKGROUND INFORMATION

Stroller boards have been attached to strollers to, for example, support a child standing thereon allowing the child to ride along behind the stroller. Conventional stroller boards have often proved difficult to operate with existing strollers. For example, a stroller board may be difficult to attach to a stroller, difficult to stow when not in use, and/or difficult to collapse with the stroller to which it is attached.

### SUMMARY

The present disclosure relates to a stroller board removably mountable to a stroller. The stroller board includes a child support platform including at least one wheel which, when the stroller board is in a use position, rests on the ground; a first arm extending between a first end coupled to the child support platform and a second end; and a first stroller board mount coupled to the second end of the first arm. The first stroller board mount has a structure that defines 1) an interior that is configured to slidably receive a terminal end of a first stroller mount of the stroller to couple the first stroller board mount to the first stroller mount or 2) a protrusion having a terminal end that is configured to be slidably received in an interior of the first stroller mount of the stroller to couple the first stroller board mount to the first stroller mount.

In an embodiment, when the first stroller board mount includes a protrusion having a terminal end configured to be slidably received in an interior of the first stroller mount, the protrusion is a bayonet-style mount and, when the first stroller board mount includes a structure configured to slidably receive a terminal end of the first stroller mount, the structure configured to slidably receive a terminal end of the first stroller mount includes a recess configured to receive a bayonet-style mount.

In an embodiment, when the first stroller board mount includes a structure configured to slidably engage the first stroller mount, the first stroller mount defines a locking cavity extending transverse to a direction of travel of the first stroller mount as it is inserted into the first stroller board mount, the locking cavity being configured to receive therein a projection of the first stroller board mount to releasably lock the first stroller board mount to the first stroller mount.

In an embodiment, the projection is a latch movable relative to the structure to releasably lock the first stroller board mount to the first stroller mount.

In an embodiment, when the first stroller mount is coupled to the first stroller board mount, the latch is movable relative to the first stroller mount between a lock position in which the latch extends into a locking cavity in the first stroller mount and a release position in which the latch is withdrawn from the locking cavity.

In an embodiment, the structure defines a stop configured to define a maximum insertion distance of the first stroller mount into the first stroller board mount.

In an embodiment, the structure includes lateral sides which constrain motion of the first stroller mount relative to the first stroller board mount permitting only insertion into the first stroller board mount and removal of the first stroller mount from the first stroller board mount along an insertion/removal axis.

In an embodiment, the first stroller board mount is rotatable relative to the first arm so that the stroller board is rotatable relative to a stroller to which the stroller board is mounted between the use position and a stowed position.

The present disclosure also relates to a system for coupling a stroller board to a stroller. The system includes a stroller including a first stroller mount; and a stroller board releasably coupleable to the stroller. The stroller board includes a child support platform including at least one wheel which, when the stroller board is in a use position, rests on the ground; a first arm extending between a first end coupled to the child support platform and a second end; and a first stroller board mount coupled to the second end of the first arm, the first stroller board mount having a structure that defines 1) an interior configured to slidably receive a terminal end of the first stroller mount or 2) a protrusion having a terminal end configured to be slidably received in an interior of the first stroller mount.

In an embodiment, the stroller includes a first child seat mounted on a frame of the stroller above the first stroller mount.

In an embodiment, the system further includes a second child seat removably mountable on the stroller, the second child seat including a first seat mount having a structure that defines 1) an interior configured to slidably receive a terminal end of the first stroller mount or 2) a protrusion having a terminal end configured to be slidably received in an interior of the first stroller mount.

In an embodiment, the first stroller mount is positioned at a rear of the stroller.

In an embodiment, the first stroller board mount includes a structure configured to slidably engage the first stroller mount and wherein the first stroller mount defines a locking cavity extending transverse to a direction of travel of the first stroller mount as it is inserted into the first stroller board mount, the locking cavity being configured to receive therein a projection of the first stroller board mount to releasably lock the first stroller board mount to the first stroller mount.

In an embodiment, the projection is a latch movable relative to the structure to releasably lock the first stroller board mount to the first stroller mount.

In an embodiment, when the first stroller mount coupled to the first stroller board mount, the latch is movable relative to the first stroller mount between a lock position in which the latch extends into a locking cavity in the first stroller mount and a release position in which the latch is withdrawn from the locking cavity.

In an embodiment, the first stroller mount includes a slot open to the locking cavity, the slot slidably receiving the latch as the first stroller mount is inserted into the first stroller board mount, the slot extending parallel to an insertion/removal axis along which the first stroller mount is coupled to and removed from the first stroller board mount.

In an embodiment, the first stroller board mount is rotatable relative to the first arm.

In an embodiment, the first stroller board mount includes a locking mechanism configured to lock the first arm in a desired rotational position relative to the first stroller board mount.

In an embodiment, the locking mechanism includes a pin on a first member of the first stroller board mount and a pin receiving space defined on a second member of the first stroller board mount, the first and second members of the first stroller board mount being rotatable relative to one another.

In an embodiment, the pin receiving space includes a locking detent adjacent thereto including a cantilevered member that deflects under a contact force from the pin permitting the pin to move into the pin receiving space.

In addition, the present disclosure relates to a stroller board removably mountable to a stroller. The board includes a child support platform including at least one wheel which, when the stroller board is in a use position, rests on the ground to maintain the child support platform in a desired position; a first arm extending between a first end coupled to the child support platform and a second end; a first stroller board mount coupled to the second end of the first arm, the first stroller board mount being configured to slidably couple to a first stroller mount of a stroller to which the stroller board is to be coupled; and a first projection extending from the first stroller board mount and positioned thereon so that, when the first stroller board mount reaches a mounting position on the first stroller mount, the first projection extends into a locking cavity of the first stroller mount to releasably lock the first stroller board mount to the first stroller mount.

### BRIEF DESCRIPTION OF THE DRAWINGS

FIG. 1 shows an assembly including a stroller and a stroller board in a disassembled state according to various exemplary embodiments described herein.

FIG. 2a shows the assembly of FIG. 1 with the stroller board in a position prior to attachment to the stroller.

FIG. 2b shows the assembly of FIG. 1 with the stroller board attached to the stroller and in a deployed position.

FIG. 2c shows the assembly of FIG. 1 with the stroller board attached to the stroller and in a storage position.

FIGS. 2d-e show the assembly of FIG. 1 with the stroller board in the storage position and the stroller in a collapsed state.

FIG. 3 shows a stroller board mount of the stroller board according to various exemplary embodiments described herein.

FIG. 4 shows a stroller mount according to various exemplary embodiments described herein.

FIGS. 5a-b show an exploded view of a rotatable end of an arm of the stroller board according to various exemplary embodiments described herein.

FIGS. 5c-e show the rotatable end of the stroller board arm in various rotation positions according to various exemplary embodiments described herein.

FIG. 6 shows an exemplary assembly including the stroller and two seats at least one of which is attached to the stroller using the exemplary locking system.

### DETAILED DESCRIPTION

The exemplary embodiments may be further understood with reference to the following description and the related appended drawings, wherein like elements are provided with the same reference numerals. The exemplary embodiments relate to an assembly comprising a stroller board that can quickly and securely connect to and disconnect from a stroller using a locking system according to the present embodiments. In an illustrative embodiment, the locking system comprises a locking system in which a projection, e.g., a movable latch, extending from a first one of the stroller or stroller board is urged into a locking position within a cavity of the other one of the stroller or stroller board under a spring force, wherein the lock can be released under a user force to disconnect the stroller board from the stroller. In other embodiments, the locking system comprises snap couplings in which a projection, e.g., a stationary pin, extending from one of the devices is brought into a locking position within a cavity of the other device by bringing the pin into contact with a deflectable detent under a user force, wherein the lock can be released under an opposing user force to disconnect the stroller board from the stroller.

In some embodiments, when attached to the stroller, the stroller board may be transitioned between a deployed position and a storage position. In the deployed position, the stroller board is extended behind the stroller for use (e.g., as a standing platform for a child). Transitioning the stroller board from the deployed position into a storage position comprises rotating the stroller board into a gap in the frame of the stroller (e.g., beneath a seat and between lateral bars or rear legs of a frame of the stroller).

In further embodiments, the assembly may be transitioned between a use state and a collapsed state in which the process for collapsing the stroller is not complicated or made more difficult by the attached stroller board and so that the footprint of the stroller in the collapsed state is substantially the same with the stroller board attached as it is when a stroller board is not attached to the stroller.

According to one aspect of the present disclosure, the stroller board and the stroller include a locking system comprising components of stroller and stroller board mounts. Each of the stroller board mounts is configured to slidably engage with and releasably lock to a corresponding one of the stroller mounts. In one embodiment, each of the stroller board mounts includes a latch for engaging a locking ledge of the corresponding stroller mount when the stroller board mounts are coupled to the stroller mounts.

In an illustrative embodiment, the latch is spring-biased to urge the latch into a locking position (i.e., where the latch is pushed into a recess to lock the stroller mount to the corresponding stroller board mount). Actuating a latch release button translates the latch against the force of the spring to disengage the latch from the locking ledge, allowing the stroller board to be removed from the stroller as will be described in greater detail below. In other embodiments, the latch is located on each of the stroller mounts (instead of the stroller board mounts), and the stroller board mounts comprise the corresponding recesses and locking ledges.

According to another aspect of the present disclosure, the stroller board comprises a rotation functionality so that the stroller board can be transitioned between a deployed position, wherein the stroller board extends rearward from the back of the stroller with the stroller board wheels facing downward, supported on and rolling over the ground, and a storage position in which the stroller board is rotated upward and forward into a gap in the frame of the stroller (e.g., to a position minimizing or eliminating interference between the stroller board and the feet of a user pushing the stroller). The rotation functionality may be implemented via a rotatable coupling between the stroller and stroller board (e.g., via a mechanism that permits the stroller and stroller board mounts to remain coupled to one another while permitting their relative rotation relative to one another.

In some embodiments, a further locking system is implemented with the rotatable couplings so that the stroller board can be locked into the storage position (e.g., by permitting the stroller board to be snap locked into the storage position). The locking system may comprise, for example, one or more pins engaging one or more deflectable detents on the opposing side of the rotatable coupling, to be described in greater detail below. Those skilled in the art will understand that the stroller board may be locked into a deployed position (i.e., the position in which the stroller board is extended rearward and down with the wheels on the ground ready to receive a child) in the same manner described above for the storage position. However, it may also be desirable to eliminate the lock for the deployed position as gravity and the weight of any child on the stroller board will effectively maintain the stroller board in the deployed position.

Those skilled in the art will understand that, although the embodiments describe a stroller board attachable to a stroller, the locking system can be implemented with a variety of other attachable devices that support a child or cargo (e.g., a child seat, bassinet, etc.) and that the attachment functionality would be the same in regard to all of these attachable devices. Thus, the description of a stroller board as the attachable device is exemplary only.

It will be further understood by those skilled in the art that the term “locking system” refers to a fastening structure comprising a male portion (sometimes referred to as a bayonet) that is configured to be received within an interior of a female portion to couple the male and female portions to one another. One of the male portion or the female portion includes a pin or latch that is configured to be received within a recess or cavity of the other of the male portion or female portion so as to lock the male and female portions to one another with respect to movement along at least one direction. Although the embodiments described herein generally refer to mechanisms for the attachment of a stroller board to a stroller with a male portion of this locking system formed by mounts of the stroller board and a female portion formed by stroller mounts including interiors for receiving the male portions of the stroller board mounts, those skilled in the art will understand that the male and female portions may be reversed so that the stroller board attachment mechanism includes the female portion of a locking system while the stroller mounts comprise the male portion.

Further, although embodiments described herein generally refer to a female portion having a pin or latch and a male portion having a recess or cavity that receives the pin or latch, those skilled in the art will understand that the female portion could alternatively have the recess or cavity and the male portion could alternatively have the pin or latch.

In the present disclosure, the locking system uses a spring urging the latch or pin into the recess or cavity when the stroller board mounts are coupled to the stroller mounts as will be described in more detail below. A latch release button is coupled to the latch so that, when pushed by a user against the force of a spring, the latch is moved out of the cavity allowing for the removal of the stroller board mount from the stroller mount and the corresponding detachment of the stroller board from the stroller.

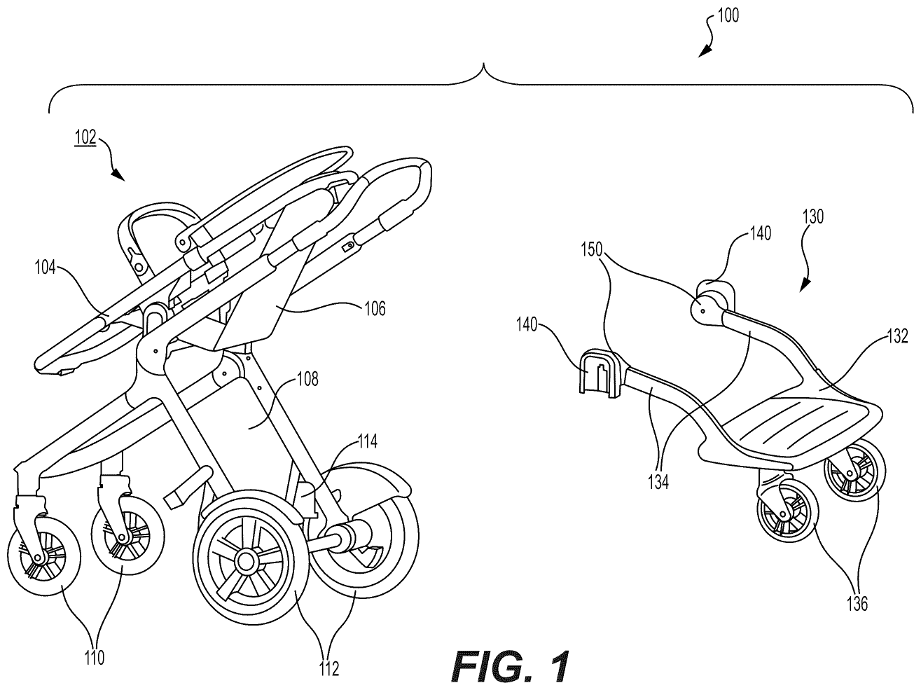

FIG. 1 shows an assembly 100 including a stroller 102 and a stroller board 130 in a disassembled state according to various exemplary embodiments described herein. The stroller board 130 is attachable to and detachable from the stroller 102 using a locking system, to be described in greater detail below. Once attached, the stroller board 130 may be transitioned between a deployed position, wherein the stroller board 130 extends rearward and downward from the rear of the stroller 102, and a storage position, wherein the stroller board 130 is rotated upward and forward into a gap 108 in a stroller frame 104 of the stroller 102 as will be described in greater detail below.

The stroller 102 may represent any type of stroller designed for compatibility with the locking system described herein. The stroller 102 includes the frame 104 supporting a child seat 106 sized and shaped to hold a child seated therein. The frame 104 further includes extensions to front wheels 110 and rear wheels 112. The front wheels 110 may, for example, be coupled to the frame 104 to allow full 360-degree rotation of the front wheels 110 relative to the frame 104 (and to the ground) for steering the stroller 102, while the rear wheels 112 may be coupled to the frame 104 in a fixed orientation relative to the frame 104.

However, those skilled in the art will understand that, if desired, both the front and rear wheels 110, 112 may be rotatable relative to the frame, only the rear wheels 112 may be rotatable or none of the wheels 110, 112 may be made rotatable without impacting the functionality of the stroller-to-stroller board mounting of the described embodiments. In the exemplary stroller 102, the rear wheels 112 are connected by an axle, while the front wheels 110 are not connected by an axle and may rotate independently of one another although this is also optional.

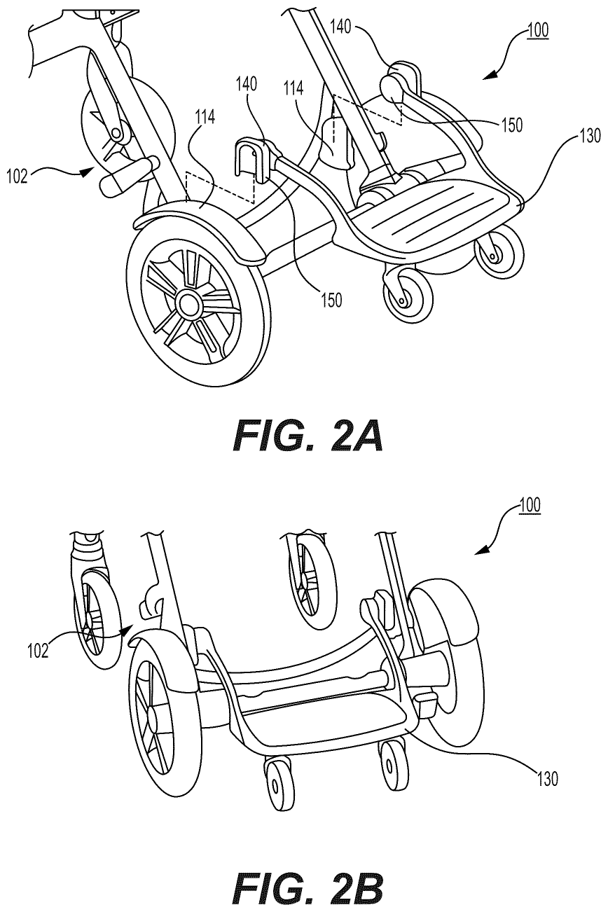

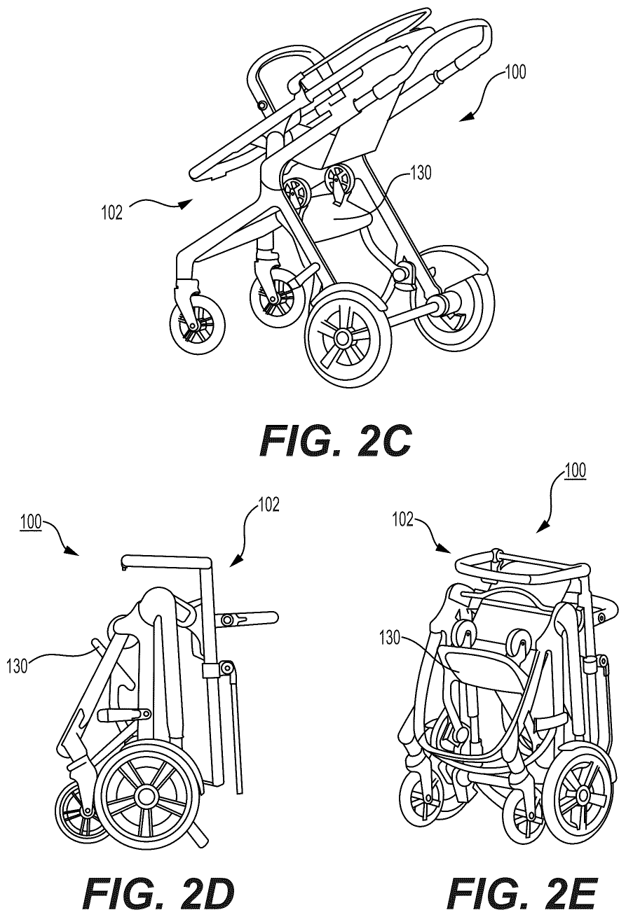

To be shown in further detail below with respect to FIGS. 2d-e, the stroller 102 may also be collapsible for ease of storage, transportation, etc. Thus, the stroller 102 may transition between a use state, in which the child seat 106 is supported by the frame 104 in an upright position and the frame 104 is fully extended, as shown for example in FIG. 1, and a collapsed state, in which the child seat 106 is moved out of the upright position or removed entirely from the frame with formerly separated portions of the frame 104 drawn closely together to reduce the footprint of the stroller 102 (e.g., for storage or transport) as shown in FIGS. 2d-e. Thus, as would be understood by those skilled in the art, the frame 104 may include suitable mechanical connections, e.g., hinges, couplings, etc., to transition the stroller 102 between the use state and the collapsed state.

The frame 104 of the stroller 102 is designed so that, in the use state, a gap 108 exists below the child seat 106 (e.g., between the child seat 106 and the ground) and between the extensions of the frame 104 supporting the rear wheels 112. The gap 108 is sized and shaped to receive the stroller board 130 when the stroller board 130 is rotated from the deployed position into the storage position, as shown for example in FIG. 2c, to be described in greater detail below. Additionally, the frame 104 is designed so that the gap 108 (or a corresponding space defined by the collapsed frame 104 of the stroller 102) can receive the stroller board 130 even when the stroller 102 is transitioned from the use state into the collapsed state, as shown in FIGS. 2d-e.

The stroller 102 further includes two stroller mounts 114 located on opposite sides of the frame 104 of the stroller 102 adjacent to the rear wheels 112, to be described in greater detail below with respect to FIGS. 2a-b and FIG. 4.

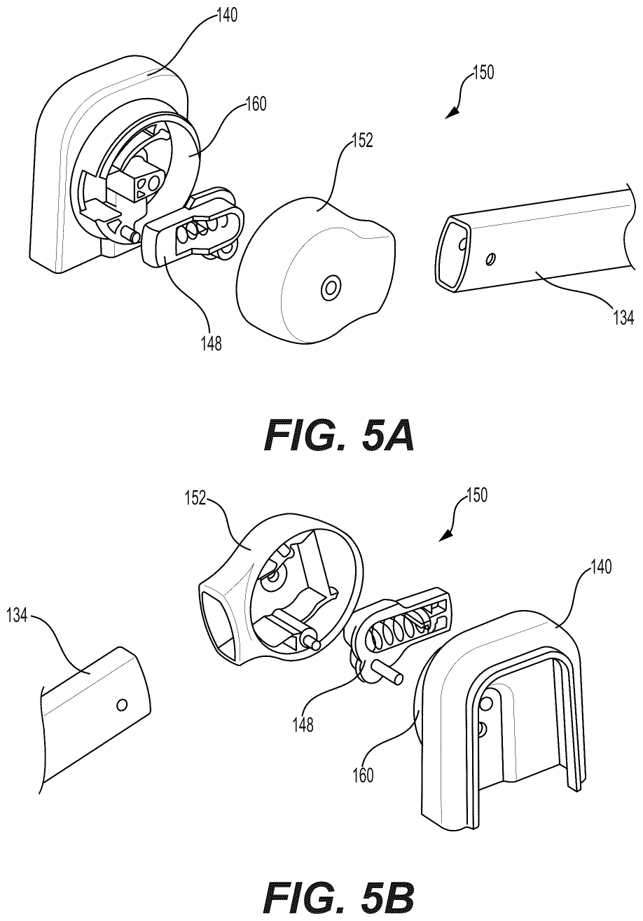

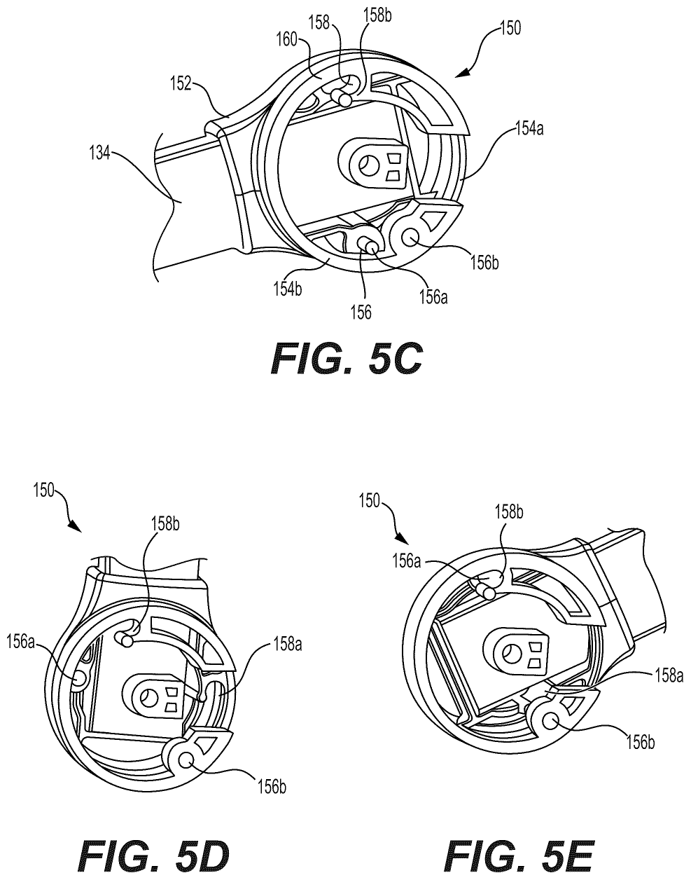

The stroller board 130 includes a board portion 132 designed to support a child standing thereon. The board portion 132 may be sized and shaped differently depending on various considerations, e.g., the approximate size and/or weight of the child it is intended to support, etc. One or more wheels 136 are positioned below the board portion 132 to engage the ground when the stroller board 130 is in the deployed state. An arm 134 extends from each of the lateral sides of the board portion 132, with each arm 134 terminating at a rotatable end 150 as will be described in greater detail below with respect to FIGS. 5a-c. The arms 134 may be sized and shaped in any suitable manner as would be understood by those skilled in the art.

For example, in the assembly 100, the arms 134 are curved so as not to interfere with the axle connecting the rear wheels 112 of the stroller 102 when the stroller board 130 is attached to the stroller 102. However, the arms 134 may be sized and shaped differently based on the other specifications of the stroller board 130, the specifications of the stroller 102 to which the stroller board 130 attaches, etc.

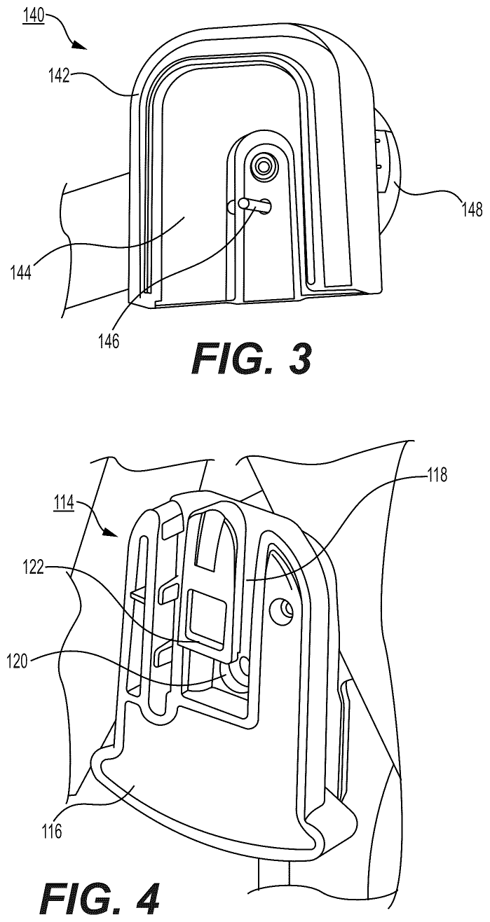

The stroller board 130 further includes two stroller board mounts 140, wherein each mount 140 is located on the outside of one of the rotatable ends 150 and is designed to couple to and decouple from a corresponding stroller mount 114 of the stroller 102, to be described in greater detail below with respect to FIGS. 3-4. Those skilled in the art will understand that the stroller mounts 114 and the stroller board mounts 140 are complimentarily sized and shaped so that, when mounted to one another, the position and orientation of each stroller mount 114 is constrained to a desired position and orientation relative to the stroller board mount 140 to which it is coupled.

As mentioned above, the stroller 102 may be any type of stroller and the stroller board 130 may be any type of stroller board in which the exemplary locking mechanism may be implemented. Thus, the stroller 102 and the stroller board 130 may be designed for compatibility with one another, wherein the stroller mounts 114 of the stroller 102 are sized, shaped and located in positions where corresponding mounts 140 of the stroller board 130 may be received. Additionally, the frame 104 may be designed to have a gap 108 in the frame structure having a size suitable to receive the stroller board 130 therein when the stroller board 130 is rotated into the storage position. The structure of the frame 104 may additionally allow the stroller 102 to collapse into the collapsed position, with the stroller board 130 attached and in the storage position, as will be described in further detail below with respect to FIGS. 2d-e.

FIG. 2a shows the assembly 100 of FIG. 1 with the stroller board 130 in a position prior to attachment to the stroller 102. The stroller mounts 114 of the stroller 102 are positioned on opposite sides of the frame 104 of the stroller 102 in locations adjacent to the rear wheels 112 of the stroller 102, facing inward toward the center of the frame 104. The mounts 140 of the stroller board 130 are positioned at the ends of opposing stroller board arms 134 of the stroller board 130, facing outward away from the center of the stroller board 130.

Between each arm 134 and its corresponding mount 140 is a rotatable end 150 permitting the arms 134 to rotate relative to the mount 140 which, in turn, permits the arms 134 and the stroller board 130 to rotate relative to the stroller 102 when the stroller board 130 is coupled to the stroller 102 as will be described in further detail below. The mounts 140 drop down onto the stroller mounts 114 and lock in place to attach the stroller board 130 to the stroller 102.

In alternative examples, the stroller and stroller board mounts 114, 140, respectively, may be reversed, such that the male portions of the locking system are located on the stroller board 130 and the female portions are located on the stroller 102.

FIG. 3 shows the mount 140 of the stroller board 130 according to various exemplary embodiments described herein. It will be understood that the exemplary mount 140 shown in FIG. 3 corresponds to the mount 140 on the left side of the stroller board 130, relative to a forward direction of the stroller board 130 and/or the stroller 102 to which it attaches. However, the structure for the mount 140 shown in FIG. 3 can be the same for the mount 140 on the right side of the stroller board 130. In the exemplary assembly 100, the structure for the left mount 140 is mirrored relative to the right mount 140, such that the locking system (e.g., latch release buttons 148 or any other suitable actuator such as, for example, a switch or a pull handle) can be actuated by a user for both mounts 140 on the same side of the mount, e.g., the rear-facing side or the forward-facing side. However, this type of arrangement is not required.

The mount 140 includes an external structure 142 defining an open-faced interior 144. The structure 142 is sized and shaped to slidably receive, in a desired position and orientation, a body 116 of the stroller mount 114 in the interior 144 when the mount 140 and stroller mount 114 are coupled, to be described in greater detail below. As indicated above, in an alternative embodiment, the stroller board mounts may be constructed as described above for the stroller mounts and the stroller mounts may be constructed as described above for the stroller board mounts.

For example, an upper-most surface of the interior of the structure 142 is positioned to define a point of maximum insertion of the body 116 of the stroller mount 114 into the interior 144 while the side surfaces of the recess in the structure 142 slidably receive the sides of the body 116 to guide the body 116 along a desired path so that a desired orientation of the body 116 relative to the structure 142 is maintained. Those skilled in the art will also understand that the side surfaces of the structure 142 may be configured to constrain movement of the body 116 as it is inserted and removed from the mount 140 to movement along an insertion/removal axis—i.e., the complimentary size and shape of the interior of the mount 140 and the exterior of the body 116 are selected to permit movement of the body 116 relative to the mount 140 only along the insertion/removal axis.

The mount 140 further includes a latch 146 extending from the structure 142 into the interior 144 through a slot in the structure 142. The latch 146 translates laterally within the slot and is spring-biased toward a first end of the slot. A latch release button 148 is connected to the latch 146 and is used to disengage the stroller board 130 from the stroller 102.

The latch release button 148 is spring-biased (e.g., by a conventional coil spring, a leaf spring or any other suitable resilient structure) toward a locked position when coupled with the stroller mount 114 and may be pushed to release the mount 140 from the stroller mount 114. The latch 146 locks below a feature on the stroller mount 114, e.g., the locking ledge 122, to be described in further detail below, so that the mount 140 cannot be translated in any direction relative to the stroller mount 114. In this example, the latch 146 and the latch release button 148 translate laterally within the interior 144 of the structure 142. In another example, the latch 146 can be a retractable plunger that retracts into and extends out of the structure 142.

FIG. 4 shows the stroller mount 114 of the stroller 102 according to various exemplary embodiments described herein. It will be understood that the exemplary stroller mount 114 shown in FIG. 4 corresponds to the stroller mount 114 on the left side of the stroller 102, when facing from the rear toward the front of the stroller 102. However, the structure for the stroller mount 114 shown in FIG. 4 may be substantially the same for the stroller mount 114 on the right side of the stroller 102 (except that it will generally be formed as a mirror image of the stroller mount 114 for the right side).

As the structure for the left stroller mount 114 is mirrored relative to the right stroller mount 114, the locking system (e.g., latch release buttons 148 or any suitable actuator as discussed above) can be actuated by a user for both mounts 140 on the same side of the mount 140 (e.g., the rear-facing side or the forward-facing side) when the user wishes to detach the stroller board 130 from the stroller 102. However, this type of arrangement is not required.

As discussed above, each side of the frame 104 includes a respective stroller mount 114 adjacent to the rear wheels 112. The stroller mount 114 includes a body 116 sized and shaped to be received within the interior 144 of the mount 140. The body 116 comprises recessed areas including a channel 118 extending from the top of the body 116 into the body 116 (e.g., along an axis generally parallel to a direction of travel of the mount 114 as it is inserted into the mount 140) and a locking cavity 120 extending transverse to the channel 118 from the base of the channel 118.

As mentioned above, in an alternative embodiment, if the latch is replaced by a retractable plunger, the vertical channel 118 may be eliminated entirely. The top of the locking cavity 120 defines a locking ledge 122 that prevents upward translation of the latch 146 when the mount 140 and the stroller mount 114 are attached and the latch release button 148 is not depressed (i.e., when the latch 146 is moved out of the channel 118 into the locking cavity 120). The channel 118 and locking cavity 120 are sized and shaped so that the latch 146 of the mount 140 can travel therein.

To attach the mount 140 to the stroller mount 114, the mount 140 is brought down over the top of the stroller mount 114 so that the body 116 is received within the interior 144 of the mount 140. When this occurs, the latch 146 of the mount 140 is drawn within the vertical channel 118 of the locking ledge. In one embodiment, the top of the channel 118 is curved so that the spring-biased latch 146 contacts the curved portion and is pushed laterally (against the force of the spring) into alignment with and received within the channel 118 as the mount 140 travels downward relative to the stroller mount 114. In another embodiment, the user may be required to actuate the latch release button 148 prior to connecting the mount 140 and the stroller mount 114 so that the latch 146 is aligned with the channel 118 during attachment.

When the mount 140 is brought down fully over the stroller mount 114 the latch 146 will be located at the end of the channel 118 adjacent to the locking cavity 120. So long as the latch release button 148 is not engaged, the latch 146 will, under the force of the spring, translate laterally into the locking cavity 120. Once the latch 146 is inside the locking cavity 120, the locking ledge 122 prevents the latch 146 from translating upward relative to the locking ledge 122. Accordingly, when this occurs, the mount 140 is locked to the stroller mount 114.

The latch 146 and the latch release button 148 of the mount 140 may be considered a single piece, e.g., a locking piece, configured to slide laterally relative to the structure 142 of the mount 140. In some embodiments, the latch 146 and the latch release button 148 can be formed as a single piece, while in other embodiments the latch 146 and the latch release button 148 can comprise separate pieces fixed to each other. This locking piece is spring-biased in the direction of the latch release button 148, i.e., the spring force acts laterally in the direction opposite the user force that can be applied to the latch release button 148, such that applying external pressure to the latch release button 148 will counteract the spring-bias and force the latch 146 laterally. When the mount 140 and the stroller mount 114 are attached, lateral movement of the latch 146 brings the latch 146 out of the locking cavity 120 and into the channel 118, after which the user can lift the stroller board 130 away from the stroller 102, moving the latch 146 upward through the channel 118 and releasing the stroller board 130 from the stroller 102.

In an alternative embodiment, the locking mechanism between the stroller board mounts 140 and the stroller mounts 114 comprises a snap coupling. For example, the stroller board mount may comprise a projection, e.g., a stationary pin, extending from the mount. The pin may be sized and shaped similarly to the latch for the locking system described above. However, in this embodiment, the pin is immovable relative to the mount structure and may not translate laterally.

The stroller mount in this embodiment comprises a longitudinal slot through which the pin is brought, similar to the locking system. However, in this embodiment, the longitudinal slot comprises a deflectable detent at the end of the slot, wherein the locking position is achieved by bringing the pin into contact with the detent and deflecting the detent under a user force to allow the pin to move past the detent into a transverse cavity. When the pin has moved past the detent, the detent is freed to move back into the relaxed state, effectively locking the pin within the cavity. To disconnect the stroller board mount from the stroller mount, the user may apply a force in the opposing direction to bring the pin back into contact with the detent and deflect the detent to allow the pin to move past the detent into the longitudinal slot. The user may subsequently remove the stroller board mount from the stroller mount.

Similar to the previously described embodiments, when the snap coupling is used, the stroller and stroller board mounts may be reversed, such that the longitudinal slot and detent are located on the stroller board and the pin is located on the stroller.

As discussed above, once attached to the stroller 102 via the locking system discussed above, e.g., the locking system or the snap coupling locking system, the stroller board 130 can additionally be rotated between a deployed position and a storage position.

FIG. 2b shows the assembly of FIG. 1 with the stroller board 130 attached to the stroller 102 and rotated into the deployed position. In the deployed position, the wheels 136 of the stroller board 130 rest on the ground so that the stroller board 130 can support a child, for example, when a caregiver is pushing the stroller 102. When the stroller board 130 is no longer needed, for example when a destination has been reached, the child may hop off of the stroller board 130 and the stroller board 130 may then be rotated into the storage position.

FIG. 2c shows the assembly of FIG. 1 with the stroller board 130 attached to the stroller 102 and in the storage position. To rotate the stroller board 130 into the storage position, an upward force is applied to the stroller board 130 by the user until the stroller board 130 passes a vertical position after which the stroller board 130 may be urged into and held in the storage position by gravity or, alternatively, may be locked in the storage position by a locking mechanism as will be described below. The rotation functionality can be implemented by a rotatable coupling within the rotatable ends 150 of the stroller board 130.

In one embodiment, the rotatable coupling comprises any suitable coupling for rotatably coupling the mounts 140 to the arms 134 while maintaining the desired mechanical coupling of the stroller board 130 and the stroller 102. For example, the rotatable ends 150 may comprise two members mechanically fastened to rotate relative to one another. As described in more detail below, one of the rotatable members in this embodiment is fixed to the mount 140, such that this first member remains fixed to the stroller 102 and includes a groove within which the second member rotates so that the remainder of the stroller board 130 to which the second member is fixed may rotate relative to the first member (and relative to the stroller 102).

Specifically, in an exemplary embodiment, the rotatable coupling comprises a locking system so that, when the stroller board 130 is rotated to a sufficient degree (and with sufficient force) to engage the lock, the stroller board 130 will remain fixed in the rotated position (e.g., the storage position) until a user rotates the stroller board 130 in the opposing direction under a sufficient force to disengage the locking system. The locking system may comprise, for example, a mechanical lock or detents.

FIGS. 5a-b shows an exploded view of the rotatable end 150 of the arm 134 according to various exemplary embodiments described herein. It will be understood that the rotatable end 150 shown in FIG. 5a represents the rotatable end 150 on the right side of the stroller board 130 (relative to the forward direction of the stroller 102 during operation by a user) and that the opposite rotatable end 150 will be similarly constructed.

However, the rotatable end 150 shown in FIG. 5a may also represent the rotatable end 150 on the opposing side of the stroller board 130. Similar to the mount 140 and the stroller mount 114 discussed above, the structure for the left rotatable end 150 is mirrored relative to the right rotatable end 150, such that the locking functionality will operate in a same global rotation direction for both of the rotatable ends 150. In other words, when the stroller board 130 is lifted and both the rotatable ends 150 rotate under the user force, the locking functionality will be reached at the same global rotation position for both rotatable ends 150.

The first member of the rotatable ends 150 includes a first piece 152 fixed to the end of the arm 134 and including a groove therein in which a second piece 160 is rotatably received for rotation relative to the first piece 152 that is fixed to the mount 140. FIGS. 5c-e show the rotatable end 150 in an assembled view, with the structure of the mount 140 omitted so that the locking mechanism may be seen with greater clarity.

The first piece 152 includes a first ring structure 154a defining a cavity. The first piece 152 further includes a first pin 156a extending toward the second piece 160 and a first storage detent 158a. The second piece 160 includes a second ring 154b defining a cavity and further includes a second pin 156b extending toward the first piece 152 and a second storage detent 158b. Those skilled in the art will understand that the rotatable coupling may include only a single pin and a single corresponding detent or any other desired number of such pin/detent combinations. The storage detents 158 (i.e., the first storage detent 158a and the second storage detent 158b) are sized and shaped to receive the pins 156 (i.e., the first pin 156a and the second pin 156b) of the opposite piece by rotating the first piece 152 relative to the second piece 160.

The storage detents 158 in this embodiment comprise deflectable, cantilevered ends arranged so that a space between the detent 158 and the ring 154 from which it extends is smaller than a width of the pin 156 to be lockingly received in the corresponding detent 158. Thus, when the first and second pieces 152, 160 are rotated relative to one another to a locking position (e.g., to the storage position), the pin 156 of one side is brought into contact with the cantilevered end of the opposing detent 158. The rotational force applied by the user pushes the pin 156 against the detent 158 deflecting the detent outward until the pin 156 passes the detent 158 to enter the interior space defined by the detent 158.

When the pin 156 enters the interior space of the detent 158, the contact force is removed from the end of the detent 158, freeing the detent 158 to return to its relaxed position and provide a lock holding the pin 156 in the interior space defined by the detent 158. The locations of the detents 158 and the corresponding pins 156 are configured so that the lock is achieved when the stroller board 130 is in the storage position. Thus, the stroller board 130 can be locked in the storage position at a desired location within the gap 108 of the frame 104. As indicated above, if desired, a similar mechanism can be employed to lock the stroller board 130 in the use position.

To return the stroller board 130 to the deployed state, a rotational force in the opposite direction is applied by the user. When the pin 156 comes into contact with the cantilevered end of the detent 158, force applied by the user to the pin 156 pushes the detent 158 and deflects it radially away from the pin 156 permitting the pin 156 to pass out of the interior space defined by the detent 158 so that the stroller board 130 may be rotated away from the locked position (e.g., from the storage position to the use position). The stroller board 130 may then be further rotated back into the deployed state.

FIGS. 5c-e show the rotatable end 150 of the arm 134 in various rotation positions according to various exemplary embodiments described herein. FIG. 5c shows the rotatable end 150 of the stroller board 130 when the stroller board 130 is in the deployed position. At the rotational position shown in FIG. 5c, the pins 156 are located a large circumferential distance from the opposing detent 158.

FIG. 5d shows the rotatable end 150 of the stroller board 130 when the stroller board 130 is in a partially rotated position. At the rotational position shown in FIG. 5d, the pins 156 are located closer to the opposing detent 158 than the scenario shown in FIG. 5c.

FIG. 5e shows the rotatable end 150 of the stroller board 130 when the stroller board 130 is in the storage position. At the rotational position shown in FIG. 5e, the pins 156 are located within the opposing detent 158. Thus, the stroller board 130 is locked into the storage position until a rotational force is applied sufficient to bring the pins 156 out of the detents 158.

As discussed above, an exemplary stroller 102 is collapsible from a use state, where the frame 104 is extended, to a collapsed state, where the frame 104 is drawn together. Thus, the frame 104 of the stroller 102 can comprise mechanical joints that allow the frame 104 to collapse, according to techniques known in the art. In addition, the frame structure of the stroller 102 according to the exemplary embodiments can be designed so that the stroller board 130 can collapse in coordination with the stroller 102.

FIGS. 2d-e show the assembly of FIG. 1 with the stroller board 130 in the storage position and the stroller 102 in the collapsed state. The orientation of the stroller board 130 can change relative to the stroller 102 when the stroller 102 is collapsed. For example, as shown in FIG. 2c, when the stroller board 130 is in the storage position with the stroller 102 in the extended state, the board portion 132 is substantially parallel to the ground. However, when the stroller 102 is transitioned into the collapsed state, the stroller board 130 translates along with the portion of the frame 104 to which it is attached. Thus, when the rear wheels 112 are brought in toward the center of the frame 104, the position of the stroller board 130 changes so that the board portion 132 is at an angle relative to the ground. Thus, the frame 104 is designed so that, in addition to providing the collapsing functionality for the stroller 102, the stroller board 130 can be collapsed with the stroller 102 without interfering with the frame 104 and/or preventing the proper collapse of the stroller 102.

Those skilled in the art will understand that, although the embodiments describe a stroller board attachable to a stroller, the locking system can be implemented with a variety of other attachable devices that support a child, such as a child seat, bassinet, etc., and that the attachment functionality would be the same in regard to all of these child support devices. Thus, the description of a stroller board as the attachable child support device is exemplary only. For example, the same stroller mounts 114 may also be used to selectively attach a second (e.g., lower) seat or any other desired stroller component to the stroller 102 when a stroller board is not attached thereto.

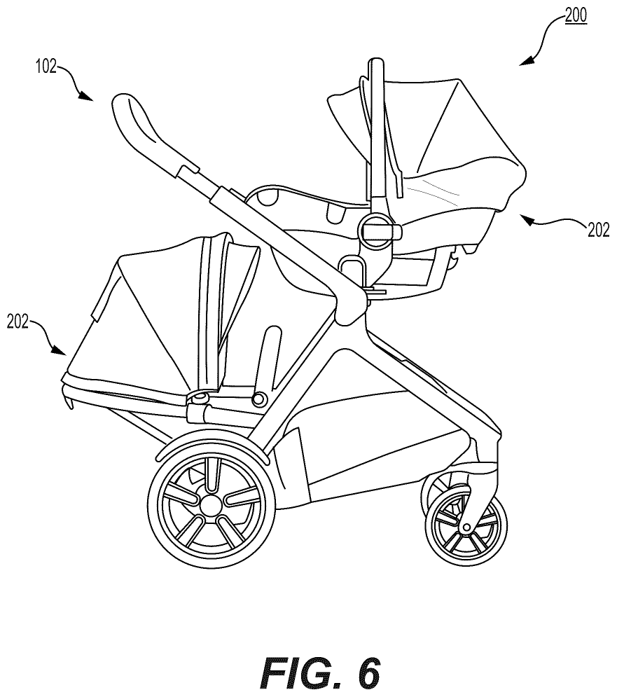

FIG. 6 shows an exemplary assembly 200 including the stroller 102 and two seats 202, at least one of which is attached to the stroller 102 using the exemplary locking system. Those skilled in the art will understand that one or more additional locking systems including stroller mounts constructed as described above, may be included at other locations on the stroller for the attachment of different components thereto. For example, a second set of stroller mounts may be attached to a portion of the stroller frame higher than the stroller mounts shown in the embodiments above that are positioned to receive the stroller board mounts. These second stroller mounts may be used, for example, to releasably couple to the stroller the upper seat shown in FIG. 6 or a bassinet, where the upper seat or bassinet includes corresponding mounts constructed as described above for the stroller board mounts.

Although this application describes various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A stroller board removably mountable to a stroller, the stroller board comprising:
a child support platform including at least one wheel which, when the stroller board is in a use position, rests on the ground;
a first arm extending between a first end coupled to the child support platform and a second end; and
a first stroller board mount coupled to the second end of the first arm, the first stroller board mount having a structure that defines 1) an interior that is configured to slidably receive a terminal end of a first stroller mount of the stroller to couple the first stroller board mount to the first stroller mount or 2) a protrusion having a terminal end that is configured to be slidably received in an interior of the first stroller mount of the stroller to couple the first stroller board mount to the first stroller mount.

2. The stroller board of claim 1, wherein, when the first stroller board mount includes a protrusion having a terminal end configured to be slidably received in an interior of the first stroller mount, the protrusion is a bayonet-style mount and, when the first stroller board mount includes a structure configured to slidably receive a terminal end of the first stroller mount, the structure configured to slidably receive a terminal end of the first stroller mount includes a recess configured to receive a bayonet-style mount.

3. The stroller board of claim 1, wherein, when the first stroller board mount includes a structure configured to slidably engage the first stroller mount, the first stroller mount defines a locking cavity extending transverse to a direction of travel of the first stroller mount as it is inserted into the first stroller board mount, the locking cavity being configured to receive therein a projection of the first stroller board mount to releasably lock the first stroller board mount to the first stroller mount.

4. The stroller board of claim 3, wherein the projection is a latch movable relative to the structure to releasably lock the first stroller board mount to the first stroller mount.

5. The stroller board of claim 4, wherein, when the first stroller mount is coupled to the first stroller board mount, the latch is movable relative to the first stroller mount between a lock position in which the latch extends into a locking cavity in the first stroller mount and a release position in which the latch is withdrawn from the locking cavity.

6. The stroller board of claim 3, wherein the structure defines a stop configured to define a maximum insertion distance of the first stroller mount into the first stroller board mount.

7. The stroller board of claim 6, wherein the structure includes lateral sides which constrain motion of the first stroller mount relative to the first stroller board mount permitting only insertion into the first stroller board mount and removal of the first stroller mount from the first stroller board mount along an insertion/removal axis.

8. The stroller board of claim 1, wherein the first stroller board mount is rotatable relative to the first arm so that the stroller board is rotatable relative to a stroller to which the stroller board is mounted between the use position and a stowed position.

9. A system for coupling a stroller board to a stroller, comprising:
a stroller including a first stroller mount; and
a stroller board releasably coupleable to the stroller, the stroller board including:
a child support platform including at least one wheel which, when the stroller board is in a use position, rests on the ground;
a first arm extending between a first end coupled to the child support platform and a second end; and
a first stroller board mount coupled to the second end of the first arm, the first stroller board mount having a structure that defines 1) an interior configured to slidably receive a terminal end of the first stroller mount or 2) a protrusion having a terminal end configured to be slidably received in an interior of the first stroller mount.

10. The system of claim 9, wherein the stroller includes a first child seat mounted on a frame of the stroller above the first stroller mount.

11. The system of claim 10, further comprising:
a second child seat removably mountable on the stroller, the second child seat including a first seat mount having a structure that defines 1) an interior configured to slidably receive a terminal end of the first stroller mount or 2) a protrusion having a terminal end configured to be slidably received in an interior of the first stroller mount.

12. The system of claim 11, wherein the first stroller mount is positioned at a rear of the stroller.

13. The system of claim 12, wherein the first stroller board mount includes a structure configured to slidably engage the first stroller mount and wherein the first stroller mount defines a locking cavity extending transverse to a direction of travel of the first stroller mount as it is inserted into the first stroller board mount, the locking cavity being configured to receive therein a projection of the first stroller board mount to releasably lock the first stroller board mount to the first stroller mount.

14. The system of claim 13, wherein the projection is a latch movable relative to the structure to releasably lock the first stroller board mount to the first stroller mount.

15. The system of claim 14, wherein, when the first stroller mount coupled to the first stroller board mount, the latch is movable relative to the first stroller mount between a lock position in which the latch extends into a locking cavity in the first stroller mount and a release position in which the latch is withdrawn from the locking cavity.

16. The system of claim 14, wherein the first stroller mount includes a slot open to the locking cavity, the slot slidably receiving the latch as the first stroller mount is inserted into the first stroller board mount, the slot extending parallel to an insertion/removal axis along which the first stroller mount is coupled to and removed from the first stroller board mount.

17. The system of claim 9, wherein the first stroller board mount is rotatable relative to the first arm and wherein the first stroller board mount includes a locking mechanism configured to lock the first arm in a desired rotational position relative to the first stroller board mount.

18. (canceled)

19. The system of claim 17, wherein the locking mechanism includes a pin on a first member of the first stroller board mount and a pin receiving space defined on a second member of the first stroller board mount, the first and second members of the first stroller board mount being rotatable relative to one another.

20. The system of claim 19, wherein the pin receiving space includes a locking detent adjacent thereto including a cantilevered member that deflects under a contact force from the pin permitting the pin to move into the pin receiving space.

21. A stroller board removably mountable to a stroller, comprising:
a child support platform including at least one wheel which, when the stroller board is in a use position, rests on the ground to maintain the child support platform in a desired position;
a first arm extending between a first end coupled to the child support platform and a second end;
a first stroller board mount coupled to the second end of the first arm, the first stroller board mount being configured to slidably couple to a first stroller mount of a stroller to which the stroller board is to be coupled; and
a first projection extending from the first stroller board mount and positioned thereon so that, when the first stroller board mount reaches a mounting position on the first stroller mount, the first projection extends into a locking cavity of the first stroller mount to releasably lock the first stroller board mount to the first stroller mount.
